(19) United States
(12) Patent Application Publication
(10) Pub. No.: US 2010/0310122 A1
(43) Pub. Date: Dec. 9, 2010

(54) Method and Device for Detecting Stationary Targets

(75) Inventors: DongHai Xie, Beijing (CN); Ying Huang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/511,058

(22) Filed: Jul. 28, 2009

(30) Foreign Application Priority Data
Jun. 3, 2009 (CN) 200910079279.6

(51) Int. Cl. G06K 9/00

(52) U.S. Cl. 382/103; 382/170

(57) ABSTRACT

Techniques for detecting stationary targets in videos or frame images are described. According to one aspect of the present invention, a sequence of frame images is being received from a video system. Each of the frame images into a plurality of image blocks, and dividing a background image is divided into a plurality of corresponding background image blocks. Characteristic values of the image blocks in each of the frame images are calculated. A plurality of characteristic value sequences is then formed, each of the characteristic value sequences comprises a predefined number of characteristic values for each of the image blocks in the frame images. A histogram of each of the characteristic value sequences is computed to determine whether one of the image blocks in one of the frame images contains a stationary target.

### BACKGROUND OF THE INVENTION

1. Field of the Invention

The present invention relates to techniques for intelligent video surveillance, more particularly to a method and a device for detecting stationary targets.

2. Description of Related Art

A conventional video surveillance system often relies on human operators to determine whether suspicious incidents happen in surveillance video. The disadvantage of the conventional video surveillance is that the operator cannot maintain a high level of vigilance all the time so that the surveillance accuracy cannot always be ensured. An intelligent video surveillance system is provided to determine whether suspicious incidents happen in surveillance video by intelligently analyzing and processing the surveillance video data.

Stationary targets are a type of important monitoring targets in the video surveillance. Accidents, e.g. illegal parking on sidewalk, illegal moving of valuables, or retention targets appearing on a defense region etc., can be captured via the stationary target detection.

Generally, the conventional method for detecting stationary targets is based on a method for detecting and tracking moving targets. The conventional method comprises: establishing a background image in which all objects being long-term stationary in the surveillance video; detecting and tracking any new objects in subsequent videos; determining these new objects as the stationary targets if the sizes and the positions of the moving targets do not change for a period of time.

However, the conventional method for detecting stationary targets may make an erroneous conclusion if the stationary targets are shadowed. Additionally, the conventional method for detecting stationary targets is sensitive to noise interference.

Thus, improved techniques for method and device for detecting stationary targets are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to techniques for detecting stationary targets in videos or frame images. According to one aspect of the present invention, a sequence of frame images is being received from a video system. Each of the frame images into a plurality of image blocks, and dividing a background image is divided into a plurality of corresponding background image blocks. Characteristic values of the image blocks in each of the frame images are calculated. A plurality of characteristic value sequences is then formed, each of the characteristic value sequences comprises a predefined number of characteristic values for each of the image blocks in the frame images. A histogram of each of the characteristic value sequences is computed to determine whether one of the image blocks in one of the frame images contains a stationary target.

One of the features, benefits and advantages in the present invention is to provide techniques for detecting motionless or stationary targets in a surveillance system.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a general flowchart showing a method for detecting stationary targets according to one embodiment of the present invention;

FIG. 2 is a specific flowchart showing a method for detecting stationary targets according to another embodiment of the present invention; and

FIG. 3 is a block diagram showing a device for detecting stationary targets according to one embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

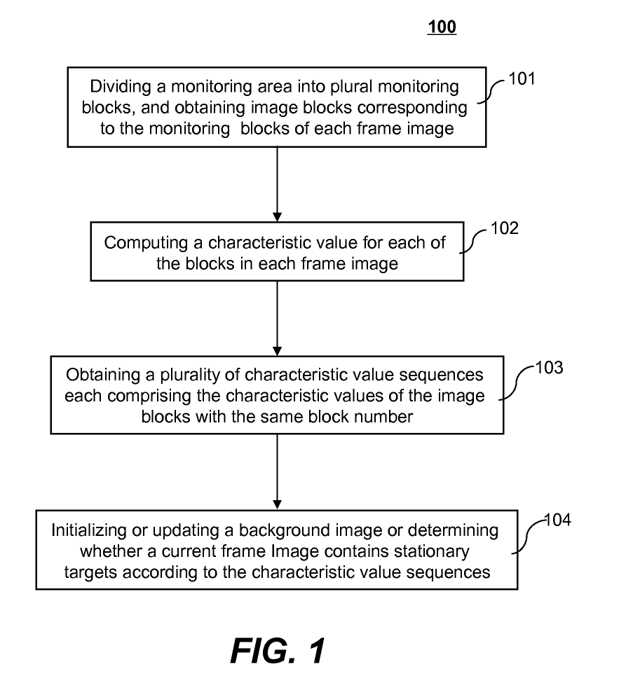

Embodiments of the present invention are discussed herein with reference to FIGS. 1-3. However, those skilled in the art will readily appreciate that the detailed description given herein with respect to these figures is for explanatory purposes only as the invention extends beyond these limited embodiments.

Improved techniques for detecting stationary targets according to one embodiment of the present invention are provided to divide each frame image into a plurality of image blocks, compute a characteristic value of each of the blocks in each frame image, and detect whether each image block contains a stationary target by analyzing the characteristic values of corresponding image blocks in different frame images. Thereby, it has a higher reliability and is insensitive to noise interference. Furthermore, the stationary targets can be detected even if it is shadowed.

FIG. 1 is a general flowchart showing a flowchart or process 100 for detecting stationary targets according to one embodiment of the present invention. The process 100 may be implemented in software, hardware or in combination of both.

At 101, a monitoring area of a video surveillance system is divided into a plurality of monitoring blocks. Accordingly, each frame image captured by the video surveillance system is divided into a plurality of image blocks. A background image is also divided into a plurality of corresponding (background) image blocks. The image blocks in different frame images correspond to each other and are assigned same block numbers.

At 102, a characteristic value of each image block of each frame image is computed. At 103, the characteristic values of the image blocks with the same block number in frame images are stored to form a characteristic value sequence, thereby a plurality of characteristic value sequences are formed. Each characteristic value sequence corresponds to one monitoring block and comprises a predefined number of characteristic values. When a new characteristic value is stored into the characteristic value sequence, the new characteristic value will push out a characteristic value firstly stored, namely first-in-first-out order.

At 104, the background image is initialized by assigning an initial characteristic value to each of the corresponding background image blocks according to a corresponding characteristic value sequence if the background image isn't initialized; otherwise, it is detected whether an image block of a current frame image contains a stationary target by comparing the characteristic value sequences with the characteristic values of corresponding background image blocks. If the image block of the current frame image contains the stationary target, the image block is outputted; otherwise, the background image block is updated according to the corresponding characteristic value sequence.

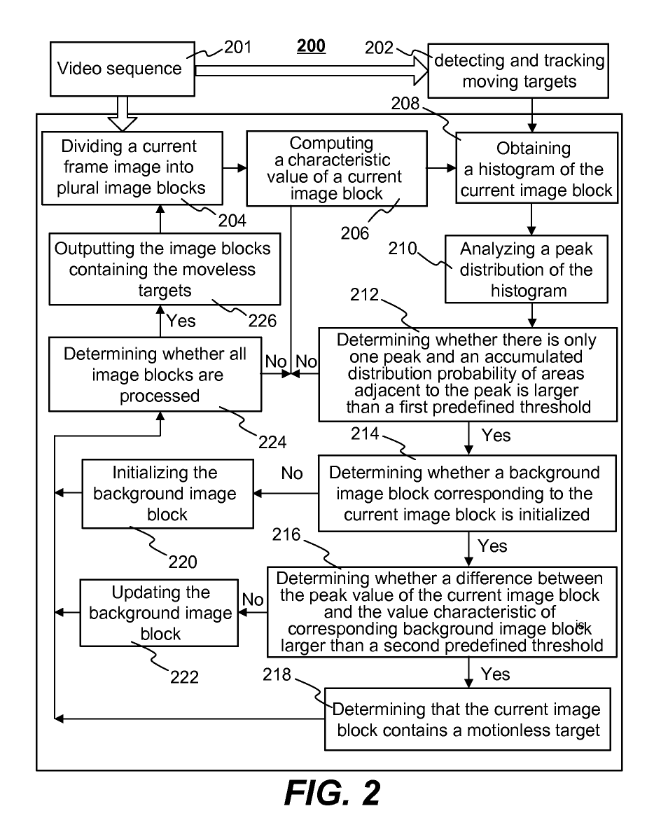

FIG. 2 is a flowchart or process 200 detecting stationary targets according to another embodiment of the present invention. At 201, a video sequence is captured by a monitoring camera of the video surveillance system. The video sequence includes a plurality of frame images. Then, the process 200 proceeds at 204, where a current frame image is divided into a plurality of image blocks. After the current frame image is processed, a next frame image of the video sequence may be used as the current frame image to continue the process 200. The size of the image block may be determined according requirements, e.g. the size of the image block may be 8*8, 16*16 or 8*16 when the frame image is 320*240 or 640*480. The image blocks with the same position in different frame images have or are assigned to the same block number.

At 206, a characteristic value of a current image block in the current frame image is computed. After the current image block is processed, a next image block of the video sequence may be used as the current image block to continue the method 200. The characteristic value may be an average (gray) value of all pixels in the current image block in one embodiment. One advantage of using the average gray value as the characteristic value is simple and fast, and the disadvantage is that it is sensitive to changes in lighting. In order to avoid the effect of lighting, some complicated characteristic values, e.g. an angle characteristic value or a gray characteristic value being insensitive to changes in lighting, can be used.

$$\begin{matrix}{G}_{M} = \frac{1}{N * N} {\sum }_{i = 0}^{N} {\sum }_{j = 0}^{N} I ( i , j ) & ( 1 ) \\ {G}_{A} = arctan ( {G}_{x} , {G}_{y} ) & ( 2 )\end{matrix}$$

Referring to the formula (1), G_{M} is the average gray value of the image block, N is the pixel length and width of the image block, I(i,j) is a gray value of a pixel (i,j) in the image block. Referring to the formula (2), G_{A} is the angle characteristic value.

The characteristic values of the image blocks with the same block number in different frame images are stored to form a characteristic value sequence, thereby a plurality of characteristic value sequences are formed. Each characteristic value sequence corresponds to one monitoring block and comprises a predefined number of characteristic values. When a new characteristic value is stored into the characteristic value sequence, the characteristic value firstly stored (in a buffer) is discarded for the newly calculated characteristic value sequence.

After 206, the characteristic value of the current image block is stored in the corresponding characteristic value sequence. The process 200 is then taken to 208, where a histogram of the current image block is obtained by counting the corresponding characteristic value sequence. At 210, a peak distribution of the histogram of the current image block is analyzed. At 212, it is determined whether there is only one peak and an accumulated distribution probability of areas adjacent to the peak is larger than a first predefined threshold. If yes, that indicates that the current image block may be stationary area, the method 200 is taken to 214; otherwise, that indicates that the current image block may be an area with motion targets, the method 200 returns to 206.

At 214, it is determined whether a background image block corresponding to the current image block is initialized. If yes, the method 200 proceeds at 216; otherwise, the method 200 enters 220, where the background image block corresponding to the current image block is initialized by assigning the peak characteristic value of the histogram of the current image block thereto. After 220, the method 200 is taken to 224. At 224, it is determined whether all image blocks of the current frame image are processed. If yes, the method 200 is taken to 226; otherwise, the method 200 is taken to 206. It is noted that all background image blocks forming one whole background image are initialized by repeatedly performing the operations 206, 208, 210, 212, 214, 220 and 224.

At 216, it is determined whether a difference between the peak characteristic value of the histogram of the current image block and the characteristic value of corresponding background image block is larger than a second predefined threshold. If yes, the method 200 is taken to 218, where it is determined that the current image block contains a stationary target; otherwise, the method 200 is taken to 222, where the background image block is updated by reassigning the peak characteristic value of the histogram of the current image block thereto. Then, the method 200 is taken to 224.

At 226, the image blocks of the current frame image containing the stationary targets are outputted. Then, the method 200 returns to 204 to continue the stationary target detection.

When a target moving slowly and having identical color appears in the monitoring scene, the target may be updated or initialized to the background image because the histogram thereof may have only one peak. In a preferred embodiment, the operation of detecting and tracking moving targets 202 is introduced into the method 200 to exclude the image blocks containing the moving targets during initializing or updating the background image, thereby minimizing effects of the moving targets on the background image.

The features and advantages in the present invention comprise: (1) the stationary targets can be detected even if the stationary targets is shadowed because of dividing the monitoring area into the plural monitoring blocks in the present invention; (2) it is insensitive to noise interference because a sequence of characteristic values of one image block are considered to determine whether the image block contains the stationary targets.

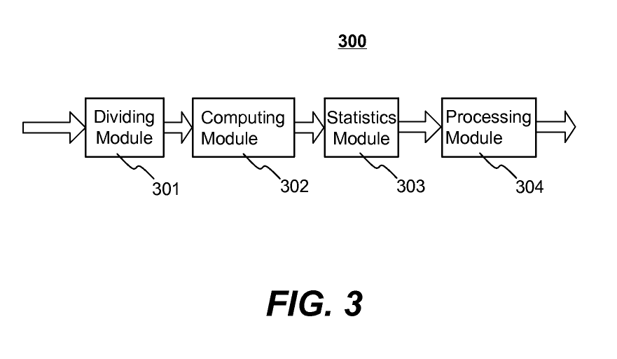

FIG. 3 is a block diagram showing a device 300 for detecting stationary targets according to one embodiment of the present invention. Referring to FIG. 3, the device 300 comprises a dividing module 301, a computing module 302, a statistic module 303 and a processing module 304.

The dividing module 301 is configured to divide each frame image into a plurality of image blocks. The image blocks in different frame images corresponding to the same position have the same block number.

The computing module 302 is configured to compute a characteristic value of each image block of each frame image.

The statistic module 303 is configured to form a plurality of characteristic value sequences each comprising a predefined number of characteristic values of the image blocks with the same block number and generate a histogram according to each characteristic value sequence.

The processing module 304 is configured to initialize each background image block according to corresponding histogram and determine whether one image block contains a stationary target by comparing corresponding histogram with corresponding background image block. If the image block contains the stationary target, the image block is outputted; otherwise, the background image block is updated according to corresponding histogram.

In a preferred embodiment, the device further comprises an excluding module configured to exclude the characteristic values of the image blocks containing the moving targets from corresponding characteristic value sequences.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for detecting stationary targets, the method comprising:
receiving a sequence of frame images from a video system;
dividing each of the frame images into a plurality of image blocks, and dividing a background image into a plurality of corresponding background image blocks;
computing characteristic values of the image blocks of each of the frame images;
forming a plurality of characteristic value sequences, each comprising a predefined number of characteristic values for each of the image blocks in the frame images;
obtaining a histogram of each of the characteristic value sequences;
determining that one of the image blocks in one of the frame images contains a stationary target if a difference between a corresponding histogram and a corresponding background image block is larger than a predefined threshold; and
updating the corresponding background image block according to corresponding histogram otherwise.

2. The method according to claim 1, wherein the characteristic value of the image block comprises an average gray value, an angle characteristic value or a gray characteristic value being insensitive to changes of lighting.

3. The method according to claim 1, wherein the forming a plurality of characteristic value sequences comprises:
putting the characteristic value of the image block into corresponding characteristic value sequence;
taking the characteristic value being firstly putted into out of corresponding characteristic value sequence.

4. The method according to claim 1, further comprising:
initializing each background image block according to corresponding histogram if the background image block isn't initialized.

5. The method according to claim 4, wherein the initializing each background image block according to corresponding histogram comprises:
assigning a peak characteristic value of corresponding histogram to each background image block.

6. The method according to claim 5, wherein the updating corresponding background image block according to corresponding histogram comprises:
assigning a peak characteristic value of corresponding histogram to corresponding background image block.

7. The method according to claim 6, wherein the difference between corresponding histogram and corresponding background image block is:
the difference between the peak characteristic value of corresponding histogram and the characteristic value of corresponding background image block.

8. The method according to claim 1, wherein after the obtaining a histogram of each characteristic value sequence, the method further comprising:
determining whether there is only one peak in corresponding histogram and an accumulated distribution probability of areas adjacent to the peak is larger than another predefined threshold; and
wherein a YES result leads to the determining that one image block of a current frame image contains a stationary target if a difference between corresponding histogram and corresponding background image block is larger than a predefined threshold.

9. The method according to claim 1, further comprising:
detecting whether the image blocks contains moving targets;
exclude the characteristic values of the image blocks containing the moving targets from corresponding characteristic value sequences.

10. A device for detecting stationary targets, comprising:
a dividing module configured to divide each frame image into a plurality of image blocks in the same way;
a computing module configured to compute a characteristic value of each image block of each frame image;
a statistic module configured to form a plurality of characteristic value sequences each comprising a predefined number of characteristic values of the image blocks with the same position in different frame images and generate a histogram according to each characteristic value sequence;
a processing module configured to store a background image comprising a plurality of background image blocks, initialize each background image block according to corresponding histogram, determine that the one image block contains the stationary target if a difference between corresponding histogram and corresponding background image block is larger than a predefined threshold, and update corresponding background image block according to corresponding histogram otherwise.

11. The device according to claim 10, wherein the characteristic value of the image block comprises an average gray value, an angle characteristic value or a gray characteristic value being insensitive to changes of lighting.

12. The device according to claim 10, wherein when a new characteristic value is putted into the characteristic value sequence, the characteristic value firstly putted into has to be taken out of the characteristic value sequence.

13. The device according to claim 10, further comprising:
an excluding module configured to exclude the characteristic values of the image blocks containing moving targets from corresponding characteristic value sequences.

14. A method for detecting stationary targets, comprising:
computing a characteristic value of a current image block of a current frame image comprising a plurality of image blocks;
putting the characteristic value of the current image block into a corresponding characteristic value sequence comprising a predefined number of characteristic values and taking the characteristic value firstly putted into out of the characteristic value sequence;
generating a histogram according to the characteristic value sequence;
determining that the current image block contains a stationary target if a difference between a peak characteristic value of the histogram and a characteristic value of a corresponding background image block of a background image comprising a plurality of background image blocks is larger than a predefined threshold;
assigning the peak characteristic value of the histogram to the corresponding background image block otherwise.

15. The method according to claim 14, wherein the characteristic value of the current image block comprises an average gray value, an angle characteristic value or a gray characteristic value being insensitive to changes of lighting.

16. The method according to claim 1, wherein after the generating a histogram of the characteristic value sequence, the method further comprising:
determining whether there is only one peak in the histogram and an accumulated distribution probability of areas adjacent to the peak is larger than another predefined threshold; and
wherein a YES result leads to the determining that the current image block contains a stationary target if a difference between a peak characteristic value of the histogram and a characteristic value of a corresponding background image block of a background image is larger than a predefined threshold.
